(19) United States
(12) Patent Application Publication
(10) Pub. No.: US 2022/0206369 A1
(43) Pub. Date: Jun. 30, 2022

(54) MOVABLE PROJECTION SYSTEM AND PROJECTION DEVICE

(71) Applicant: IVIEW DISPLAYS (SHENZHEN) COMPANY LTD., Shenzhen (CN)

(72) Inventors: Guoming Lu, Shenzhen (CN); Wenxiang Li, Shenzhen (CN); Mingnei Ding, Shenzhen (CN); Steve Yeung, Hong Kong (CN); Zhiqiang Gao, Hong Kong (CN)

(21) Appl. No.: 17/537,609

(22) Filed: Nov. 30, 2021

Related U.S. Application Data
(63) Continuation of application No. PCT/CN2021/082410, filed on Mar. 23, 2021.

(30) Foreign Application Priority Data
Dec. 31, 2020 (CN) 202023348760.1

(51) Int. Cl. G03B 21/14; G03B 21/54

(52) U.S. Cl. CPC G03B 21/145; G03B 21/54

(57) ABSTRACT

The present disclosure provide a movable projection system and a projection device. The movable projection system includes a cabinet, a projection unit, a moving unit, an image acquisition unit, an interaction unit, a communication unit, and a control unit. The control unit is connected to the projection unit, the moving unit, the image acquiring unit, the interaction unit, and the communication unit, and configured to control, based on the interaction information of the communication unit, the input information of the interaction unit and the image information of the image acquisition unit, the projection unit to project the content and the moving unit to move.

### CROSS-REFERENCE TO RELATED APPLICATIONS

This application is a continuation-application of International (PCT) Patent Application No. PCT/CN2021/082410, filed on Mar. 23, 2021, which claims priority to Chinese Patent Application No. 202023348760.1, filed with the National Intellectual Property Administration of China on Dec. 31, 2020, and entitled “MOVABLE PROJECTION SYSTEM AND PROJECTION DEVICE”, the entire contents of which are incorporated herein by reference.

### TECHNICAL FIELD

Embodiments of the present disclosure relate to the technical field of projection and display, and in particular, relate to a movable projection system and a projection device.

### BACKGROUND

In a related route guidance device, generally signs or panorama or suspended projection devices are arranged in a specific place, and such configurations may not conveniently guide persons to their destinations. In addition, the related route guidance device only provides a single scenario, and may not meet personalized guidance requirements.

### SUMMARY

An embodiment of the present disclosure provides a movable projection system. The movable projection system includes: a cabinet, defining a receiving space; a projection unit, disposed in the receiving space, and configured to project content to a projectable region in a traveling direction of the movable projection system; a moving unit, disposed on a first side of the cabinet, and configured to drive the movable projection system to move; an image acquisition unit, disposed on a second side of the cabinet, and configured to acquire image information of the outside; an interaction unit, disposed on a surface of the cabinet, and configured to generate a two-dimensional code and receive input information of a user. The user inputs interaction information by scanning the two-dimensional code on a mobile terminal; a communication unit, disposed in the receiving space, connected to the mobile terminal, and configured to receive the interaction information input by the user on the mobile terminal; and a control unit, disposed in the receiving space, connected to the projection unit, the moving unit, the image acquiring unit, the interaction unit, and the communication unit, and configured to control, based on the interaction information of the communication unit, the input information of the interaction unit and the image information of the image acquisition unit, the projection unit to project the content and the moving unit to move.

Another embodiment of the present disclosure provides a projection device. The projection device includes a movable projection system. The movable projection system includes: a cabinet, defining a receiving space; a projection unit, disposed in the receiving space, and configured to project content to a projectable region in a traveling direction of the movable projection system; a moving unit, disposed on a first side of the cabinet, and configured to drive the movable projection system to move; an image acquisition unit, disposed on a second side of the cabinet, and configured to acquire image information of the outside; an interaction unit, disposed on a surface of the cabinet, and configured to generate a two-dimensional code and receive input information of a user. The user inputs interaction information by scanning the two-dimensional code on a mobile terminal; a communication unit, disposed in the receiving space, connected to the mobile terminal, and configured to receive the interaction information input by the user on the mobile terminal; and a control unit, disposed in the receiving space, connected to the projection unit, the moving unit, the image acquiring unit, the interaction unit, and the communication unit, and configured to control, based on the interaction information of the communication unit, the input information of the interaction unit and the image information of the image acquisition unit, the projection unit to project the content and the moving unit to move.

### BRIEF DESCRIPTION OF THE DRAWINGS

One or more embodiments are illustrated by way of example, and not by limitation, in the figures of the accompanying drawings, wherein elements/modules and steps having the same reference numeral designations represent like elements/modules and steps throughout. The drawings are not to scale, unless otherwise disclosed.

FIG. 1 is a schematic structural diagram of a movable projection system according to an embodiment of the present disclosure.

FIG. 2 is a schematic structural diagram of another movable projection system according to an embodiment of the present disclosure.

### DETAILED DESCRIPTION

The present disclosure is further described with reference to some exemplary embodiments. The embodiments hereinafter facilitate further understanding of the present disclosure for a person skilled in the art, rather than causing any limitation to the present disclosure. It should be noted that persons of ordinary skill in the art may derive various variations and modifications without departing from the inventive concept of the present disclosure. Such variations and modifications shall pertain to the protection scope of the present disclosure.

For better understanding of the present disclosure, the present disclosure is described in detail with reference to attached drawings and specific embodiments. Unless the context clearly requires otherwise, throughout the specification and the claims, technical and scientific terms used herein denote the meaning as commonly understood by a person skilled in the art. Additionally, the terms used in the specification of the present disclosure are merely for describing the objectives of the specific embodiments, and are not intended to limit the present disclosure. As used herein, the term “and/or” in reference to a list of one or more items covers all of the following interpretations of the term: any of the items in the list, all of the items in the list and any combination of the items in the list.

It should be noted that, in the absence of conflict, embodiments of the present disclosure and features in the embodiments may be incorporated, which all fall within the protection scope of the present disclosure. In addition, although function module division is illustrated in the schematic diagrams of apparatuses, and in some occasions, module division different from the divisions of the modules in the apparatuses may be used. Further, the terms “first”, “second”, and the like used in this text do not limit data and execution sequences, and are intended to distinguish identical items or similar items having substantially the same functions and effects.

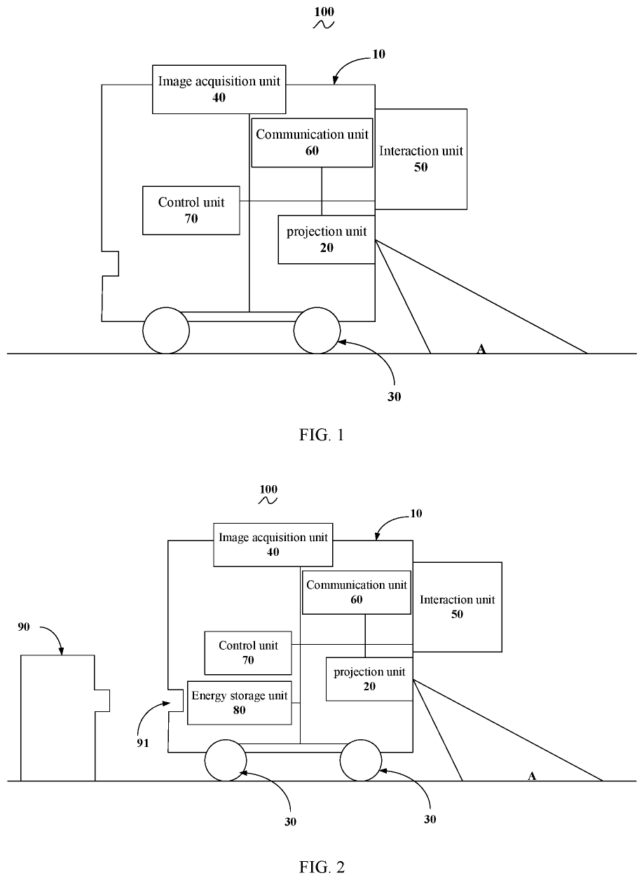

Referring to FIG. 1, a schematic structural diagram of a movable projection system according to an embodiment of the present disclosure is illustrated. The movable projection system includes a cabinet 10, a projection unit 20, a moving unit 30, an image acquisition unit 40, an interaction unit 50, a communication unit 60, and a control unit 70. The cabinet 10 is provided with a receiving space. The projection unit 20, the communication unit 60, and the control unit 70 are disposed in the receiving space, the moving unit 30 is disposed on a first side of the cabinet 10. The image acquisition unit 40 is disposed on a second side of the cabinet 10, and the second side is opposite to the first side. The interaction unit 50 is disposed on a surface of the cabinet 10; the projection unit 20 is configured to project content to a projectable region A in a traveling direction of the movable projection system 100, the moving unit 30 is configured to drive the movable projection system to move, the image acquisition unit 40 is configured to acquire image information of the outside, the interaction unit 50 is configured to generate a two-dimensional code and receive input information of a user. The user inputs interaction information by scanning the two-dimensional code on a mobile terminal, and the communication unit 60 is configured to receive the interaction information input by the user on the mobile terminal; the control unit 70 is connected to the projection unit 20, the moving unit 30, the image acquiring unit 40, the interaction unit 50, and the communication unit 60, and configured to control, based on the interaction information of the communication unit 60, the input information of the interaction unit 50 and the image information of the image acquisition unit 40, the projection unit 20 to project the content and the moving unit 30 to move.

In an embodiment, in this system, the image acquisition unit 40 is a camera. In the case that the image acquisition unit 40 acquires a person or an object, the interaction unit 50 is triggered, and a user may input information via the interaction unit 50, or the user may enter a relevant page by scanning the two-dimensional code of the interaction unit 50 on the mobile terminal, and input interaction information via the relevant page. Subsequently, the control unit 70 generates road guidance information based on destination information input by the user, and sends the road guidance information to the projection unit 20 to project the road guidance information. For example, road guide icons may be projected onto the ground to provide guide information for the user. Meanwhile, the control unit 70 may generate road moving information based on the information of the image acquisition unit 40, to control the moving unit 30 to drive the system to move, such that a specific person or object is guided to arrive at the destination. In the movable projection system, based on the interaction information input by the user, the projection unit is controlled to project the content and the moving unit 30 is controlled to drive the system to move, such that the user is guided in real time, and personalized guidance requirements are met.

In some embodiments, referring to FIG. 2, the movable projection system 100 further includes an energy storage unit 80. The energy storage unit 80 is disposed in the receiving space, connected to the projection unit 20, the moving unit 30, the image acquisition unit 40, the communication unit 60, the interaction unit 50, and the control unit 70, and configured to store electric energy and supply power to the movable projection system 100. In an embodiment, the energy storage unit 80 is a battery set or any other suitable energy storage devices.

In some embodiments, still referring to FIG. 2, the movable projection system 100 further includes a charging unit 90. The charging unit 90 is disposed outside the cabinet 10, the cabinet 10 is provided with a charging port 91, the charging port 91 is connected to the energy storage unit 80, and the charging unit 90 is configured to be connected to the charging port 91 and charge the energy storage unit 80 via the charging port 91. In an embodiment, the charging unit 90 is a charging pile or any other suitable charging devices.

In some embodiments, still referring to FIG. 2, the moving unit 30 includes at least two caster wheels. In an embodiment, the moving unit 30 further includes at least one motor. The motor is connected to the caster wheels. In the case that the moving unit 30 receives moving information of the control unit 70, the motor starts to rotate, and the caster wheels are controlled to move in a specific direction, such that the movable projection system arrives at a destination.

In some embodiments, the movable projection system 100 further includes an automatic focusing unit and a correction unit. The automatic focusing unit and the correction unit are both connected to the control unit 70 and the projection unit 20, the automatic focusing unit is configured to perform automatic focusing on the content for projection, and the correction unit is configured to perform trapezoidal correction on the content for projection. In this way, the movable projection system 100 achieves convenient and high-quality projection.

In some embodiments, the communication unit 60 includes at least one of a Wi-Fi module, a Bluetooth module, a 4G module, and a 5G module. In practice, the communication unit 60 may be configured as any other suitable communication units, which is not limited to the description in this embodiment.

In some embodiments, the interaction unit 50 includes a touch display and a microphone. The touch display and the microphone are both connected to the control unit. The touch display may be configured to receive input information of a user, and generate a two-dimensional code. The microphone is configured to receive voice-based input information of the user. The control unit 70 may acquire interaction information by processing the voice-based input information of the user. In other embodiments, the interaction unit 50 includes a speaker. The speaker is connected to the control unit 70, and configured to broadcast prompt information to enhance user experience.

To solve the above technical problem, in a second aspect, the embodiments of the present disclosure provide a projection device. The projection device includes the movable projection system according to the first aspect. In the projection device, based on the interaction information input by the user, the projection unit is controlled to project the content and the moving unit is controlled to drive the projection device to move, such that the user is guided in real time, and personalized guidance requirements are met.

The embodiments of the present disclosure provide a movable projection system and a projection device. The movable projection system includes a cabinet, a projection unit, a moving unit, an image acquisition unit, an interaction unit, a communication unit, and a control unit. The control unit is connected to the projection unit, the moving unit, the image acquiring unit, the interaction unit, and the communication unit, and configured to control, based on the interaction information of the communication unit, the input information of the interaction unit and the image information of the image acquisition unit, the projection unit to project the content and the moving unit to move. In the movable projection system, based on the interaction information input by the user, the projection unit is controlled to project the content and the moving unit is controlled to drive the system to move, such that the user is guided in real time, and personalized guidance requirements are met.

It should be noted that the above described device embodiments are merely for illustration purpose only. The units which are described as separate components may be physically separated or may be not physically separated, and the components which are illustrated as units may be or may not be physical units, that is, the components may be located in the same position or may be distributed into a plurality of network units. Part or all of the modules may be selected according to the actual needs to achieve the objectives of the technical solutions of the embodiments.

Finally, it should be noted that the above embodiments are merely used to illustrate the technical solutions of the present disclosure rather than limiting the technical solutions of the present disclosure. Under the concept of the present disclosure, the technical features of the above embodiments or other different embodiments may be combined, the steps therein may be performed in any sequence, and various variations may be derived in different aspects of the present disclosure, which are not detailed herein for brevity of description. Although the present disclosure is described in detail with reference to the above embodiments, persons of ordinary skill in the art should understand that they may still make modifications to the technical solutions described in the above embodiments, or make equivalent replacements to some of the technical features; however, such modifications or replacements do not cause the essence of the corresponding technical solutions to depart from the spirit and scope of the technical solutions of the embodiments of the present disclosure.

1. A movable projection system, comprising:
a cabinet, defining a receiving space;
a projection unit, disposed in the receiving space, and configured to project content to a projectable region in a traveling direction of the movable projection system;
a moving unit, disposed on a first side of the cabinet, and configured to drive the movable projection system to move;
an image acquisition unit, disposed on a second side of the cabinet, and configured to acquire image information of the outside;
an interaction unit, disposed on a surface of the cabinet, and configured to generate a two-dimensional code and receive input information of a user, wherein the user inputs interaction information by scanning the two-dimensional code on a mobile terminal;
a communication unit, disposed in the receiving space, connected to the mobile terminal, and configured to receive the interaction information input by the user on the mobile terminal; and
a control unit, disposed in the receiving space, and connected to the projection unit, the moving unit, the image acquiring unit, the interaction unit, and the communication unit, the control unit being configured to control, based on the interaction information of the communication unit, the input information of the interaction unit and the image information of the image acquisition unit, the projection unit to project the content and the moving unit to move.

2. The movable projection system according to claim 1, further comprising an energy storage unit; wherein the energy storage unit is disposed in the receiving space, and connected to the projection unit, the moving unit, the image acquisition unit, the communication unit, the interaction unit, and the control unit, the energy storage unit being configured to store electric energy and supply power to the movable projection system.

3. The movable projection system according to claim 2, wherein the energy storage unit comprises a battery set.

4. The movable projection system according to claim 2, further comprising a charging unit; wherein the charging unit is disposed outside the cabinet, the cabinet is provided with a charging port, the charging port is connected to the energy storage unit, and the charging unit is configured to be connected to the charging port and charge the energy storage unit via the charging port.

5. The movable projection system according to claim 1, wherein the moving unit comprises at least two caster wheels.

6. The movable projection system according to claim 5, wherein the moving unit further comprises at least one motor, the motor being connected to the caster wheels.

7. The movable projection system according to claim 1, further comprising an automatic focusing unit and a correction unit; wherein the automatic focusing unit and the correction unit are both connected to the control unit and the projection unit, the automatic focusing unit is configured to perform automatic focusing on the content for projection, and the correction unit is configured to perform trapezoidal correction on the content for projection.

8. The movable projection system according to claim 1, wherein the communication unit comprises at least one of a Wi-Fi module, a Bluetooth module, a 4G module, and a 5G module.

9. The movable projection system according to claim 1, wherein the interaction unit comprises a touch display and a microphone.

10. A projection device, comprising a movable projection system; wherein the movable projection system comprises:
a cabinet, defining a receiving space;
a projection unit, disposed in the receiving space, and configured to project content to a projectable region in a traveling direction of the movable projection system;
a moving unit, disposed on a first side of the cabinet, and configured to drive the movable projection system to move;
an image acquisition unit, disposed on a second side of the cabinet, and configured to acquire image information of the outside;
an interaction unit, disposed on a surface of the cabinet, and configured to generate a two-dimensional code and receive input information of a user, wherein the user inputs interaction information by scanning the two-dimensional code on a mobile terminal;
a communication unit, disposed in the receiving space, connected to the mobile terminal, and configured to receive the interaction information input by the user on the mobile terminal; and
a control unit, disposed in the receiving space, and connected to the projection unit, the moving unit, the image acquiring unit, the interaction unit, and the communication unit, the control unit being configured to control, based on the interaction information of the communication unit, the input information of the interaction unit and the image information of the image acquisition unit, the projection unit to project the content and the moving unit to move.

11. The projection device according to claim 10, further comprising an energy storage unit; wherein the energy storage unit is disposed in the receiving space, and connected to the projection unit, the moving unit, the image acquisition unit, the communication unit, the interaction unit, and the control unit, the energy storage unit being configured to store electric energy and supply power to the movable projection system.

12. The projection device according to claim 11, wherein the energy storage unit comprises a battery set.

13. The projection device according to claim 11, further comprising a charging unit; wherein the charging unit is disposed outside the cabinet, the cabinet is provided with a charging port, the charging port is connected to the energy storage unit, and the charging unit is configured to be connected to the charging port and charge the energy storage unit via the charging port.

14. The projection device according to claim 10, wherein the moving unit comprises at least two caster wheels.

15. The projection device according to claim 14, wherein the moving unit further comprises at least one motor, the motor being connected to the caster wheels.

16. The projection device according to claim 10, further comprising an automatic focusing unit and a correction unit; wherein the automatic focusing unit and the correction unit are both connected to the control unit and the projection unit, the automatic focusing unit is configured to perform automatic focusing on the content for projection, and the correction unit is configured to perform trapezoidal correction on the content for projection.

17. The projection device according to claim 10, wherein the communication unit comprises at least one of a Wi-Fi module, a Bluetooth module, a 4G module, and a 5G module.

18. The projection device according to claim 10, wherein the interaction unit comprises a touch display and a microphone.
